(19) United States
(12) Patent Application Publication
(10) Pub. No.: US 2015/0057790 A1
(43) Pub. Date: Feb. 26, 2015

(54) CONTROL SYSTEM FOR CONTROLLING AT LEAST ONE WELDING PROCESS

(71) Applicant: Robert Bosch GmbH, Stuttgart (DE)

(72) Inventor: Dhruv Kalia, Murrhardt, DE (US)

(21) Appl. No.: 14/464,263

(22) Filed: Aug. 20, 2014

(30) Foreign Application Priority Data
Aug. 20, 2013 (DE) 10 2013 216 421.1

(51) Int. Cl. G05B 19/18; H04L 29/08

(52) U.S. Cl. CPC G05B 19/182; H04L 67/10; G05B 2219/45135
USPC 700/212

(57) ABSTRACT

A control system for controlling at least one welding process includes at least two welding controllers and at least two operator interfaces configured to control the welding controllers. The control system further includes at least one web page display element that is configured to communicate with at least one of the at least two welding controllers and the at least one operator interface and/or is included in the at least two welding controllers. The at least one web page display element is configured to query welding parameters of the at least two welding controllers continuously or at temporal predefinable intervals of time and/or control the at least two welding controllers dependently or independently of each other.

This application claims priority under 35 U.S.C. §119 to patent application no. DE 10 2013 216 421.1 filed on Aug. 20, 2013 in Germany, the disclosure of which is incorporated herein by reference in its entirety.

The disclosure relates to a control system for controlling at least one welding process and to a method for controlling a control system for at least one welding process.

### BACKGROUND

Some control systems are already known. For example, such control systems comprise at least two welding controllers and at least two operator interfaces for controlling the welding controllers. However, it has hitherto been customary for the operator to have to turn toward the respective operator interfaces, which could usually be found in the immediate surrounding area of the welding controllers, in order to control the welding controllers. In other words, such an operator interface was centrally fitted to or in the area of the welding controllers. These control systems which are already known and are intended to control at least one welding process are not very operator-friendly, however, since the respective operator had to move away from his workstation to the usually centrally arranged operator interface in order to be able to control or program a welding process. Such a central arrangement of the operator interfaces on or in the area of the welding controllers therefore previously hindered a workflow and often resulted in time-consuming and laborious welding processes since the user was compelled to move away from his workstation to the centrally arranged operator interface for each change to the welding process.

In addition, it has hitherto been possible only with difficulty to control a plurality of welding processes at the same time by means of the operator interfaces and, in particular, in a manner matched to one another. An overview of peak loads of the entire control system for controlling at least one welding process was therefore previously not possible.

### SUMMARY

Therefore, an object of the disclosure is to provide a control system for controlling at least one welding process, in which it is possible to control and/or monitor a multiplicity of welding processes, for example simultaneously running welding processes, in a decentralized manner and to monitor and/or control said processes at the same time via a communication connection in a particularly simple, cost-effective and time-saving manner.

This object is achieved by the subject matter as described below. Advantageous embodiments are also described below.

In order to now specify a control system for controlling at least one welding process, in which it is possible to control and/or monitor a welding process in a decentralized manner, for example via the Internet, in a particularly simple, reliable, cost-effective and time-saving manner, the present disclosure uses, inter alia, the idea of the control system comprising at least one web page display element which communicates, in particular via the Internet, with the welding controllers and/or the operator interfaces and/or is included in the welding controllers themselves, in which case welding parameters of the welding controllers can be queried continuously or at temporal predefinable intervals of time via the web page display element and/or the welding controllers can be controlled dependently or independently of one another via the web page display element. The web page display element may be an Internet-enabled program which can be run on a computer and/or downloaded to a computer and/or can at least be displayed. In addition, the web page display element may comprise such a computer on which such a program can be run. This program can then be in the form of and/or can be operated in the manner of the HTML/JS/CSS programming languages and/or representation languages.

In this respect, a look-and-feel sense which is as homogeneous as possible and a particularly reliable control possibility irrespective of the source of the web page are also possible at any time.

According to at least one embodiment, the control system for controlling at least one welding process comprises at least two welding controllers and at least one, in particular at least two, operator interface(s) for controlling the welding controllers and at least one web page display element which communicates (via the Internet) with the welding controllers and/or the operator interfaces and via which welding parameters of the welding controllers can be queried continuously or at temporal predefinable intervals of time and/or the welding controllers can be controlled dependently or independently of one another via the web page display element.

According to at least one embodiment, the web page display element is set up and provided for the purpose of displaying and/or generating at least one status and/or control web page, the status and/or control web page being formed and/or displayed using a programming code in the form of Hypertext Preprocessor (PHP) and/or Apache Velocity programming languages.

According to at least one embodiment, the control system comprises at least one interface layer, control commands from an operator interface being at least partially transmitted to the welding controllers as a control and/or querying command via the at least one interface layer. In particular, the interface layer may be in the form of a software layer or may comprise at least one software layer. In this case, the term “layer” is part of a computer system, in particular a hierarchically organized computer system. In the field of control and/or computer programming, “layering” is normally used to subdivide an organization of the entire control and/or program control, in particular in a hierarchical respect, into individual functional components which operate separately from one another, each of the functional components being sequentially or hierarchically connected to one another and/or being made dependent on one another.

In this respect, the term “layer” can be interpreted in the form of a metaphorically conceived “computer layer” which converts and reinterprets operating commands from the operating elements for the welding controllers into the appropriate programming language and/or the appropriate control and/or querying commands for the individual welding controllers.

In other words, in accordance with the control system for controlling at least one welding process which is described here, the operator of the control system can advantageously access any of the welding controllers, in particular independently, and also at the same time, for example, from a conventionally produced line PC irrespective of the local situation.

This is because production lines and, in particular, welding lines are often very extensive, with the result that the operator previously often had to go to the installation site of each individual welding controller in order to be able to access the latter. Avoiding a point-to-point connection therefore makes it possible for a plurality of line PCs to simultaneously access a plurality of welding controllers. Such avoidance of the point-to-point connection is described and enabled, in particular, by the at least one “interface layer” described here, thus implementing a so-called client/server principle.

As already mentioned above, the control system described here namely enables access by a multiplicity of operators (for example at least one and at most 25) via the interface layers each assigned, for example uniquely assigned, to the operator interfaces, a combination with a multiplicity (for example up to 100) of different welding controllers at the same time.

The reasons for such desired simultaneous access to such a multiplicity of welding controllers can also be seen in the fact that the respective operators wish to have flexibility to the effect of being able to change or read the respective welding parameters from the different welding controllers. This is because such reading is preferably enabled from each of the welding controllers independently of one another according to the disclosure.

In addition, it is possible to install an early warning system on the control system, for example in a manner displayed graphically on a display or another screen, which early warning system can provide, in particular, relating to an electrode status of individual or all welding controllers inside a control cell, a control cell being able to comprise at least two or more welding controllers. This early warning system can be displayed most of the time for all welding controllers for this purpose.

It is also conceivable that not all welding errors or deviations from a welding normal range which are caused by the welding controllers (based in each case on a welding cell comprising a predefinable number of welding controllers) must have effects in all remaining welding controllers or must be displayed in all other welding controllers.

In addition, the disclosure proposed here makes it possible to read reference curves for each welding controller into or from the latter, the welding controllers described here preferably being organized in a predefinable manner in a control cell.

In principle, the applicant in the disclosure was also guided by the thought that general loading of a single welding controller and, in particular, overloading of a single welding controller should be avoided and possible welding tasks which have been incorrectly programmed and are to be carried out twice are also minimized and the overall performance based on the welding time and/or the welding quality of the control system should also remain within a normal error range and the production tolerance. In addition, it was important for the inventors that the operator is not limited to the use of specifically selected and specific welding systems or to only a small selection of welding systems, but rather the operator should have the greatest possible flexibility when selecting the individual welding controllers by means of input to the respective operator interfaces.

According to at least one embodiment, the at least two welding controllers are connected to one another via at least one communication network. In this respect, it is advantageously possible not only for the two operator interfaces to be connected to a welding controller assigned to each operator interface, for example, via a communication network, but rather for the welding controllers to be communicatively connected to one another, for example for the purpose of interchanging information. In this respect, a quite particularly variable control system which is particularly well matched is provided.

According to at least one embodiment, the two welding controllers are directly connected to the operator interface via at least one communication line. In this context, “directly” means that no intermediate computer, which again interprets control commands from the interface to layer, is connected at least between the interface layer and the welding controllers, for example. Therefore, such a “direct” communication connection between the individual welding controllers and the operator interfaces makes it possible to control the welding controller in a particularly prompt and immediate manner. A loss of time with respect to an update for individual welding parameters or qualities of the welding electrodes which is continuously generated during the welding process is therefore avoided and updates without a time delay are enabled.

According to at least one embodiment, firmware of at least one welding controller can process at least two control and/or querying commands at the same access time of two operating stations. Such firmware is ideally suitable for use in the “direct” connection between the welding controllers of the operator interfaces since the firmware processes and can direct the multiplicity of parallel connections for all requests, for example querying commands. In this respect, it is possible to establish a first system topology in the form of peer-to-peer communication.

According to at least one embodiment, each operator interface comprises at least one interface layer and at least one graphical user interface (GUI). The graphical user interface may be, for example, a graphical user interface to a Java application. The user interface described here makes it possible for a plurality of querying commands, for example, to be transmitted to the individual welding controllers without a loss of performance and time to the individual welding controllers. It is therefore advantageously possible for the performance of the user interface to not be reduced, but rather for the performance required by the individual user interfaces to be divided among the respective different operator interfaces by virtue of the integration in each operator interface, with the result that overloading of the system can be avoided in a particularly effective manner. This can also be part of the first system topology mentioned above.

According to at least one embodiment, the control system comprises at least one communication server which, for the purpose of communication transmission, is connected between each of the operator interfaces, preferably between the interfaces, and the welding controllers, the entire communication transmission from the operator interfaces to the welding controllers and vice versa being controlled and/or managed by the communication server. Such interposition of the communication server can be considered to be a second system topology.

In this embodiment variant, the main aspect is aimed at using a minimum of individual communication channels of the welding controllers to establish communication.

In other words, the communication server described here acts as a “middle layer” between the individual operator interfaces and the individual welding controllers.

In particular, it is conceivable for the communication server to be operated or to be able to be operated using a Windows service. In this respect, it is conceivable for the Windows service to comprise programs in the form of WinXP/Win7/Win2003/2008 or the like.

In this respect, it is conceivable for welding controllers which are already present in a production process to be able to be used for such a configuration and for a connection to the communication server, with the result that it is advantageously possible to dispense with welding controllers which are specifically matched to the communication server, in particular, for example welding controllers which are to be newly produced. This therefore provides a particularly effective cost advantage.

In this respect, the task of the communication server is to maintain communication among the corresponding welding controllers and, in particular, with the operator interfaces.

It is therefore advantageously possible for the operators and, in particular, for the operator interfaces to interchange data only with the central communication server, the data from the individual welding controllers being stored in the communication server, for example continuously, or being retrieved from the respective welding controllers by said communication server and being stored in the communication server. In this respect, the communication server described here may be in the form of a multiplexer. In this case, it is conceivable for the communication server and/or the central server described below to comprise the web page display element described here.

In other words, the individual operator interfaces are not immediately and directly connected to the corresponding welding controllers, with the result that a connection architecture and a process of connecting to the individual interfaces can be especially simplified, in particular also as a result of the firmware described here. This is because, in order for information to reach the individual welding controllers, it is necessary to access only the communication server described here.

In order to achieve the highest possible production throughput and a low error tolerance, the communication server described here can also avoid the same orders being carried out twice, which should absolutely be avoided. The communication server is able to do so, in particular, also because said communication server is arranged in a particularly central manner between the individual operator interfaces and the welding controllers and can therefore simultaneously process different queries and/or control commands from the individual operator interfaces at the same time, can compare them with one another and can forward them to the welding controllers. In this respect, it is conceivable for individual connections to individual welding controllers to be able to be set up via the communication server and, on the other hand, for individual control operations for the individual operator interfaces to also likewise be able to be set up by the communication server independently thereof, for example. In this respect, a client/server communication topology is formed as a special implementation of the control topology 2 described here.

According to at least one embodiment, only some of the operator interfaces comprise at least one graphical user interface (GUI), and the remaining user interfaces are stored on the communication server. In this respect, the task of the user interfaces, that is to say that of establishing a fundamental communication connection between the operator elements a welding controller, is advantageously at least partially transferred to the communication server. In this respect, instead of the communication tasks being completely undertaken by the communication server, as described above, it is conceivable for a partial load to likewise be able to be circulated to the operator interfaces, that is to say in a decentralized manner.

According to at least one embodiment, the at least one interface layer and/or the at least one user interface (GUI) is/are stored on a central computer different from the operator interfaces. For example, the central computer is a communication server or a server which is additionally different therefrom. In this respect, the of the user interface is also moved from the individual operator interfaces to the central computer and/or the communication server as a result of its integration on the central computer, thus relieving the load on the individual operator interfaces in terms of performance.

In this respect, it is possible for the individual tasks (jobs) which are transmitted from different operator interfaces to the communication server, for example, to be centrally allocated to a single welding controller. In particular, a control map (mapping table) can be stored in the communication server, which map archives and stores the individual tasks of individual operator interfaces and presents and stores said tasks in an optically readable manner, for example in terms of time or according to priority (that is to say importance).

The task map (mapping table) can therefore be used for the purpose of comparing whether a task, that is to say a welding process, which is due to be carried out by the control system, has already been carried out in the past and/or for the purpose of detecting which operator or which operator interface should be informed of the result of the task, that is to say of the completion of the task and/or a quality of the task, for example.

In addition, synchronization of the individual welding controllers can be produced in a particularly simple manner and can also be maintained using the communication server described here since a maximum number of control parameters for carrying out the individual tasks can be directly produced by the communication server and can be forwarded to the individual welding controllers without interrupting or disrupting a welding process or different welding processes of the individual welding controllers.

In other words, task balancing (load balancing) can be carried out in a particularly simple manner and redundancy (task repetition) can be completely prevented and, in addition, all operators or operator interfaces can be in contact with the communication server, for example using a router which may be included in the communication server, using the router via the router itself.

In this case, flexibility in the selection of the individual tasks or else of the special communication server can be effected with the aid of file management systems and files in the form of XML/INI.

As a purely exemplary example, it is conceivable for the control system to comprise 100 welding controllers and 10 operator interfaces, as a result of which the following configurations are possible by way of example:
All 10 operator interfaces have installed a user interface (GUI);
an operator interface no. 1 is configured only for the welding controllers 1-25;
an operator interface no. 2 is configured only for connection to the welding controllers 26-50;
an operator interface no. 3 is configured only for connection to the welding controllers 51-75;
an operator interface no. 4 is configured only for connection to the welding controllers 76-100.

As mentioned above by way of example, such an arrangement ensures that the 100 welding controllers can be distributed among only four line PCs, for example, and can be controlled by the latter.

According to at least one embodiment, a central computer of the control system comprises the communication server, the user interface (GUI) and/or at least one communication router. A third system topology in the form of a Communication Topology Using Server Platform can therefore be implemented. A particularly compact control system is provided if such a central computer comprises the communication server, the user interface and the communication router. In particular, the central computer may be a particularly powerful computer belonging to an operator, for example a particularly powerful operator interface (line PC). It is therefore conceivable for the user interface to be available for different decentralized users in the form of terminal sessions. In addition, the routing and communication transmission can be combined and carried out in a Windows service. In this case, all user interfaces can communicate with the communication transmissions.

In this respect, the operations of installing and updating the software used to operate the control system become very simple since only the central server has to be updated for a software update. This immediately results in the configuration effort being minimized and in scaling of the overall system ultimately leading only to upgrading of the RAM and therefore in no installations having to be carried out at the operator interfaces.

In addition, a method for operating a control system for controlling at least one welding process is specified. For example, a control system, as described in at least one of the embodiments cited above, can be implemented using the method.

According to at least one embodiment, the method for operating a control system has a first step, according to which at least two welding controllers and at least one, in particular at least two, operator interface(s) for controlling the welding controllers are initially provided, and the control system has at least one web page display element which communicates with the welding controllers and/or the operator interfaces via the Internet and/or is included in the welding controllers themselves, in which case, in a second step, welding parameters of the welding controllers are queried continuously or at temporal predefinable intervals of time via the web page display element and/or the welding controllers are controlled dependently or independently of one another via the web page display element.

In this case, the method described below has the same advantages and configurations as the control system described here.

### BRIEF DESCRIPTION OF THE DRAWINGS

The control system described here and the method described here are explained in more detail below in the associated exemplary embodiments using figures.

FIGS. 1A-1C show different exemplary embodiments of a control system described here in the individual topologies.

FIG. 2 shows a schematic table view of the individual suitability stages of the topologies 1-3 presented here with respect to different installation and operation factors.

FIG. 3 shows an embodiment of a control system described here in the form of a topology 1 described here and a topology 2 described here.

FIG. 4 shows an embodiment of an Internet-enabled communication connection between the individual welding controllers and a web page display element described here.

In the exemplary embodiments and in the figures, identical or identically acting parts are each provided with the same reference symbols. The elements illustrated here should not be considered as being true to scale, but rather individual elements may be illustrated on an excessively large scale for the sake of better understanding.

### DETAILED DESCRIPTION

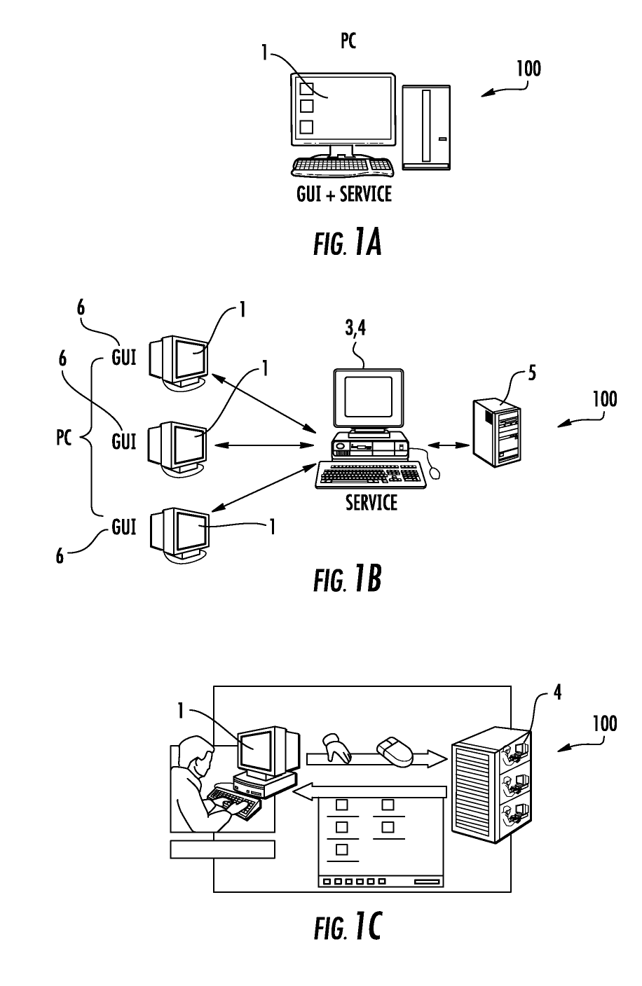

FIG. 1A uses a schematic illustration to illustrate an exemplary embodiment of a control system 100 described here for controlling a multiplicity of welding processes. In this respect, it can be seen from FIG. 1A that this control system comprises at least one operator interface 1 in the form of a line PC, the operator interface 1 comprising a user interface (GUI) described here and an interface layer described here. In this respect, each PC is directly connected to the respective welding controllers 5 and a control topology 1 is implemented. In addition, each welding controller 5 is connected to at least one web page display element 7 via at least one Internet connection.

FIG. 1B illustrates, in a further exemplary embodiment, a control topology 2 in which a communication server 3 is set up, which communication server, for the purpose of communication transmission, is connected between each of the operator interfaces 1 and, in particular, between the interfaces and user interfaces and the welding controllers 5, the entire communication transmission from each of the operator interfaces 1 to the welding controllers 5 and vice versa being controlled and/or managed by the communication server 3.

FIG. 1C illustrates, in another exemplary embodiment, the control topology 3 which has already been mentioned above and in which a central computer 4 is included in the control system 100, which central computer in turn comprises the communication server 3 and the user interface (GUI) and also a communication router. In other words, the individual operator interfaces 1 have more processor power for operation by the respective user, for example, with the result that complicated process management is transferred to the central computer 4 described here.

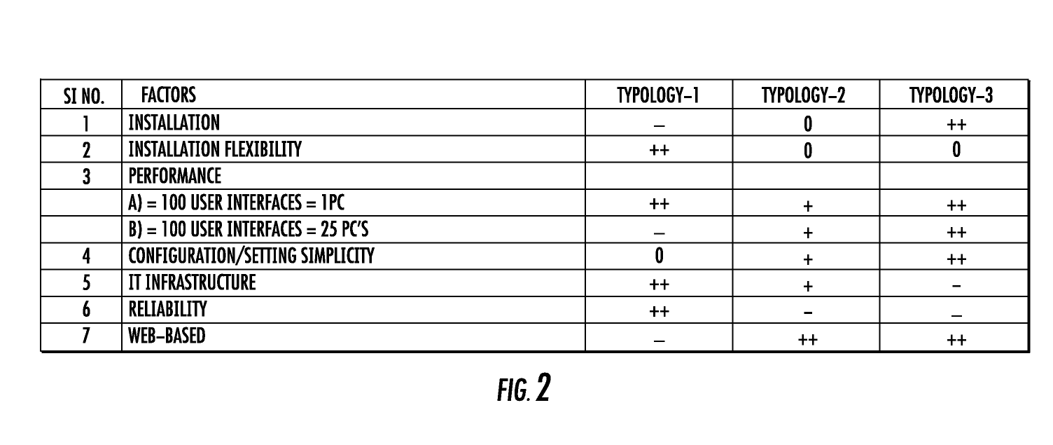

FIG. 2 shows, in a schematic table, individual advantages with respect to individual installation and/or operating factors of the control system 100 described here with respect to the individual system topologies 1-3 illustrated here. In this case, the table illustrated there is self-explanatory, in which case a “+” represents an advantage for the respective user, a “0” represents a neutral relationship in comparison with the two other topologies and a “−” represents a rather unfavorable situation in comparison with the two other topologies with respect to the individual factors.

In this respect, it can be gathered from the above-described table in FIG. 2 in a particularly simple manner that different topologies appear to be advantageous for different factors which are individually selected and preferred by the respective operator, and the individual topologies 1-3 for respective corresponding usage situations of the control system 100 are adapted to the specific welding requirements and/or are selected.

In particular, it is conceivable to be able to change between the individual topologies 1-3 described here in a predefinable manner, for example using a service based on “Windows Communication Foundation” (WCF), with the result that the individual operator or the individual operator interfaces 1 can choose between the individual topology operating variants in a predefinable and/or automatic manner according to each requirement situation and said topology operating variants can be combined with one another in a predefinable manner in terms of time.

In this respect, the present case involves a control system 100 which can generally be operated with a scalable topology, in which case the scalable topology described here can be used for different installation and operating models with respect to the individual topologies 1-3.

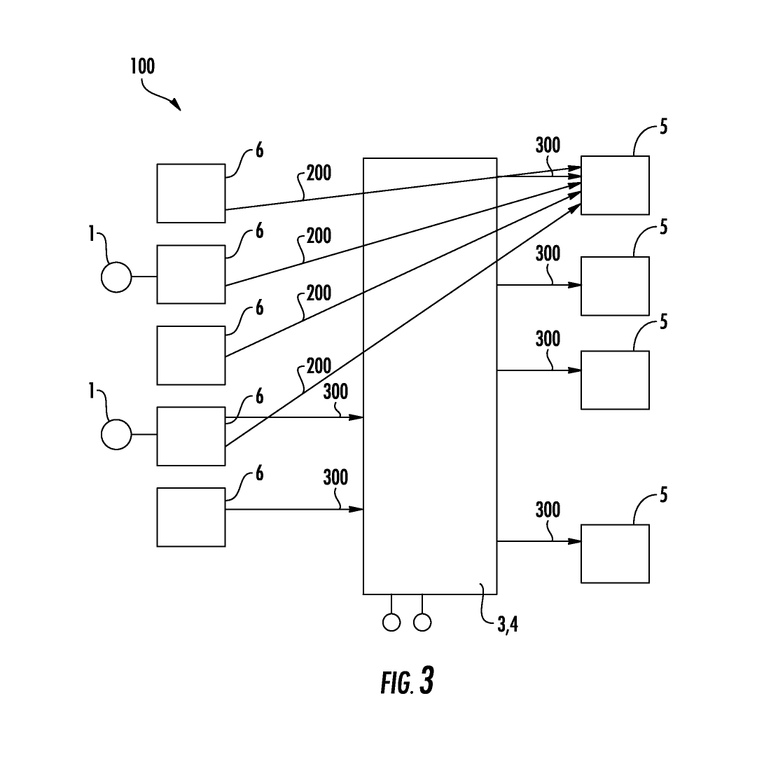

FIG. 3 schematically illustrates the two topologies 1 and 2 by means of arrow communication. As illustrated by arrows 11 of the topology 1, it can be seen that each of the welding controllers 5 directly communicates with the individual welding controllers 5, and it can be seen, by arrows 12 of the topology 2 that a common central communication server 3 in the form of a central computer 4 is interposed, for the purpose of communication, between the individual welding controllers 5 and the operator interfaces 1.

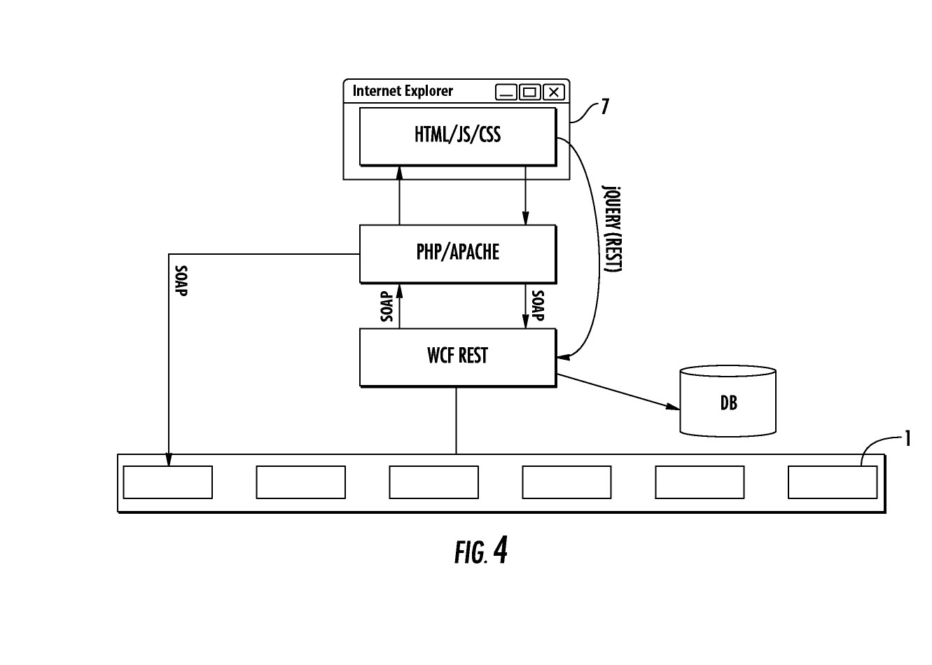

FIG. 4 shows a schematic illustration of an Internet-enabled communication connection between the individual welding controllers and a web page display element 7 described here. It can be seen that each of the welding controllers is connected, for example, to the communication server 3 described here and/or a central computer 4 described here. In particular, it is mentioned that a common web page view of web pages generated by the communication server 3, the central server 4 and/or the welding controllers 1 described here is enabled by the web page display element 7.

In this case, the abbreviation “WCF Rest” is a Windows Communication Foundation/Representational State Transfer, “jQuery” is a JavaScript library for client side scripting and “SOAP” is a Simple Object Access Protocol, in which case “DB” is generally a database, for example the central computer 4 described here.

The disclosure is not restricted by the description using the exemplary embodiments. Rather, the disclosure comprises any new feature and the combination of features, which includes, in particular, any combination of features in the patent claims, even if this feature or combination itself is not explicitly stated in the patent claims or in exemplary embodiments.

### LIST OF REFERENCE SYMBOLS

1 Operator interface
3 Communication server
4 Central computer
5 Welding controllers
6 User interface (GUI)
7 Web page display element
100 Control system

What is claimed is:

1. A control system for controlling at least one welding process, the control system comprising:
at least two welding controllers;
at least one operator interface configured to control the at least two welding controllers; and
at least one web page display element that is at least one of: (i) configured to communicate with at least one of the at least two welding controllers and the at least one operator interface; and (ii) included in the at least two welding controllers
wherein the at least one web page display element is configured to at least one of: (i) query welding parameters of the at least two welding controllers continuously or at temporal predefinable intervals of time; and (ii) control the at least two welding controllers dependently or independently of each other.

2. The control system according to claim 1, wherein the at least one web page display element is configured to at least one of display and generate a status web page that is at least one of formed and displayed using a programming code.

3. The control system according to claim 2, further comprising:
at least one interface layer,
wherein control commands from the at least one operator interface are at least partially transmitted to the welding controllers as at least one of a control and querying command via the at least one interface layer.

4. The control system according to claim 1, wherein the at least two welding controllers are connected via at least one communication network.

5. The control system according to claim 1, wherein the at least two welding controllers are directly connected to the at least one operator interface via at least one communication line.

6. The control system according to claim 1, wherein firmware of one of the at least two welding controllers are configured to process at least one of at least two control and query commands during a simultaneous access of two operating stations.

7. The control system according to claim 1, wherein the at least one operator interface comprises at least one interface and at least one graphical user interface.

8. The control system according to claim 1, further comprising:
at least one communication server,
wherein the at least one operator interface is at least two operator interfaces;
wherein the at least one communication server is connected to each of the at least two operator interfaces; and
wherein the at least one communication server is configured to at least one of control and manage communication transmission between the at least two operator interfaces and the at least two welding controllers.

9. The control system according to claim 8, wherein at least one of the at least two operator interfaces comprise at least one interface and at least one graphical user interface, and another of the at least two operator interfaces are formed by the communication server.

10. The control system according to claim 8, wherein the at least one interface layer is stored on a central computer different from the at least two operator interfaces.

11. The control system according to claim 10, wherein the central computer comprises at least one of: (i) the communication server; (ii) the at least one graphical user interface; and (iii) at least one communication router.

12. A method for operating a control system for controlling at least one welding process, the method comprising:
controlling at least two welding controllers via at least one operator interface;
at least one of: (i) communicating, via the at least one web page display element, with at least one of the at least two welding controllers and the at least one operator interface; and (ii) including the at least one web page display element in the at least two welding controllers; and
at least one of: (i) querying, via the at least one web page display element, welding parameters of the at least two welding controllers continuously or at temporal predefinable intervals of time; and (ii) controlling, via the at least one web page display element, the at least two welding controllers dependently or independently of each other.

13. The control system according to claim 1, wherein the at least one web page display element is configured to communicate with at least one of the two welding controllers and the at least one operator interface via the internet.

14. The control system according to claim 1, wherein the at least one web page display element is configured to at least one of display and generate a control web page that is at least one of formed and displayed using a programming code.

15. The control system according to claim 2, wherein the programming code is in the form of at least one of Hypertext Preprocessor (PHP) and Apache Velocity programming languages.

16. The control system according to claim 14, wherein the programming code is in the form of at least one of Hypertext Preprocessor (PHP) and Apache Velocity programming languages.
